(19) United States
(12) Patent Application Publication
(10) Pub. No.: US 2016/0143332 A1
(43) Pub. Date: May 26, 2016

(54) STABLE OIL SUSPENSIONS WITH ENHANCED BIOAVAILABILITY AND COMPOSITIONS THEREOF

(71) Applicant: OmniActive Health Technologies Limited, Lower Parel (IN)

(72) Inventors: Jayant DESHPANDE, Charlottetown (CA); Laxman KATE, Thane (W) (IN); Prakash BHANUSE, Thane (W) (IN)

(21) Appl. No.: 14/631,093

(22) Filed: Feb. 25, 2015

(30) Foreign Application Priority Data
Nov. 26, 2014 (IN) 3739/MUM/2014

(51) Int. Cl. A23L 1/30; A23D 9/007; A23L 1/00

(52) U.S. Cl. CPC A23L 1/3002; A23L 1/3006; A23L 1/0008; A23L 1/0032; A23D 9/007; A23V 2002/00

(57) ABSTRACT

Stable oil suspensions are described that have enhanced bioavailability and contain lipophilic nutrients uniformly dispersed in a solid hydrophilic carrier and suspended in an oil medium. A process for preparation of stable oil suspensions of lipophilic nutrients and compositions of these suspensions such as soft gelatin capsules are also described. The oil suspensions include soluble granules of lipophilic nutrients suspended in oil. Soluble granules include lipophilic nutrients dispersed uniformly in a solid hydrophilic carrier with one or more food grade excipient. Stable oil suspensions of the invention include at least 1% to about 50% lipophilic nutrient. These oil suspensions are resistant to oxidation and exhibit enhanced stability and bioavailability as compared to soluble granules and to marketed comparative products. Oil suspensions herein can be encapsulated in soft gel capsules or filled in sachets to administer conveniently to patients.

### FIELD

Stable oil suspensions of lipophilic nutrients are described herein which include soluble granules suspended in oil medium, and which exhibit enhanced bioavailability. Soluble granules include a lipophilic nutrient uniformly dispersed in an effective amount of at least one solid hydrophilic carrier, and can also include food grade excipient(s). Processes for preparation of soluble granules in a stable oil suspension are described herein. Soluble granules are prepared by uniformly dispersing lipophilic nutrient in an effective amount of solid hydrophilic carrier, and are suspended in a suitable oil medium to form a suspension which is stable over the shelf life of the composition. Stable oil suspensions can be further formulated or converted such as for example being encapsulated in soft gel capsules, filled in sachets or adsorbed onto solid carriers to form granules for beverage applications or can be filled in gelatin capsules and are useful for skin and eye care.

### BACKGROUND

Lipophilic nutrients are essential for maintaining good health and prescribed by nutritionists for curing certain deficiencies in the body. Owing to their lipophilic nature, these nutrients exhibit low aqueous solubility and permeability through body membranes. Since the gastrointestinal tract is an aqueous environment, and since only dissolved molecules can be taken up by the body, these nutrients often show limited bioavailability.

Looking at the wide range of lipophilic nutrients which are essential for health, such as fatty acids, fat soluble vitamins, glycerides, carotenoids, curcumin, capsaicin, coenzyme Q 10, as well as Ubiquinol, the challenge of oral bioavailability of these nutrients is very high. In order to increase solubility of nutrients and enhance therapeutic efficacy, different techniques are employed. These can be decreasing particle size of the nutrient, use of solubilizers, complexation with excipients such as Beta cyclodextrin, saccharin, milling with surfactants, solid dispersions, melt granulation and the like.

Along with increasing solubility of lipophilic nutrients, it is also desirable to formulate such nutrients into dosage forms which are stable, owing to the inherent instability due to the chemical structure, because of which these nutrients are prone to oxidative degradation.

Various publications are directed to increase solubility of lipophilic nutrients or formulate such nutrients into various dosage forms.

U.S. Pat. No. 8,748,495 relates to a method for preparing a carotenoid oil suspension, by treating carotenoid crystals with tetrahydrofuran to remove non-soluble phospholipids in order to get oil suspension with low viscosity and high fluidity. The resulting crystals are ground and mixed with plant oils to provide a carotenoid oil suspension, which provides easy filling, for example, into capsules. Thus the application aims at providing an oil suspension having low viscosity to aid in processing it into soft gel capsules.

Japanese patent application JP2012006943A relates to a stable microcapsule product with high levels of carotenoid. The microcapsules are coated with a protective coating of a sugar or polyhydric alcohol, a starch or dextrin, and optionally a protein, which release carotenoids upon ingestion of the microcapsules. The microcapsules are formed using a fluidized bed coating machine for spraying the coating material.

U.S. patent application US20140030419A1 relates to a carotenoid oil suspension and preparation method which includes the steps of mixing carotenoid with organic solvent, heating the mixture to dissolve the carotenoid sufficiently; introducing the carotenoid solution into an oil solution which is stirred at high speed by spraying to obtain carotenoid oil suspension. Such oil suspension comprises a carotenoid crystal with an average particle size of less than 5 μm.

U.S. patent application US20130216512A1 relates to an aqueous suspension of a hydrophobic nutrient which is prepared by treating the nutrient with a selected dispersion aid such as triglyceride, an essential oil such as night primrose oil, fish oil, and a mixture to form a modified nutrient compound. Such compound is then combined with a dispersion agent such as lecithin, hydrocolloid or surfactant in aqueous medium under high shear to form a stable aqueous suspension.

Another U.S. patent application US20130310302A1 relates to use of a rice endosperm protein as novel protective hydrocolloid for fat-soluble nutrient ingredients. These compositions are used for the enrichment, fortification and/or coloration of food, beverages, animal feed, personal care or pharmaceutical compositions.

PCT application WO2012139895A1 relates to a process for the manufacture of a powder containing lutein and food composition containing said powder. As per the patent application, lutein is suspended in an aqueous solution/suspension of a polysaccharide and the resulting suspension is milled followed by drying to obtain lutein particles having mean particle size of less than 0.6 micrometer.

U.S. patent application US20120039970A1 relates to a ready-to-use stable suspension of partially amorphous carotenoid particles and a process for the production thereof, wherein carotenoid and edible oil are dissolved in a water-miscible organic solvent or water-immiscible organic solvent. This solution is mixed with a molecularly dispersed or colloidally dispersed solution of a hydrophilic protective colloid in a mixture of water and polyhydric alcohol. The carotenoid-comprising hydrophobic phase is produced as a nanodispersed hydrophobic phase and the organic solvent is removed thus concentrating the suspension formed.

U.S. Pat. No. 6,616,942 relates to a method for improved absorption of lipophilic nutrient from intestinal tract by administration in a soft gel capsule of a formulation of a mixture of lipophilic nutrients in rice bran oil and a thickener such as beeswax. The process comprises heating rice bran oil and adding beeswax to the heated rice bran oil to which a mixture of lipophilic nutrients is added. The resultant mixture is cooled and encapsulated in a soft gel capsule.

Although such prior literature describe treatment of lipophilic nutrients with excipients such as surfactants, colloids, proteins, waxes, oils or organic solvent vehicles, these do not address problems of low solubility of these inherently hydrophobic nutrients. Use of an excessive amount of surfactants to increase solubility of actives is not allowed in nutraceutical formulations, owing to its taste, odor and consumer acceptability. Further merely suspending these lipophilic nutrients into oils, waxes or organic solvents do not tackle the underlying problem of stability, solubility and therefore bioavailability. The lipophilic nutrients are poorly absorbed if merely administered either as oil suspensions or as beadlets. This is because the main reason for poor absorption is their poor solubility in water.

### SUMMARY

Thus there is need of alternate formulation approaches for lipophilic nutrients so as to design dosage forms with enhanced stability, solubility, and bioavailability and which are convenient to administer in their stable form.

Designing dosage forms for lipophilic nutrients which increase stability and exhibit enhanced therapeutic effectiveness, and can result in obtaining desirable positive health benefits, would be advantageous.

Having carried out exhaustive trials and formulated stable and bioenhanced oil suspensions by following a stepwise approach of first tackling the problem of inherent poor water solubility of lipophilic nutrient and then addressing the stability issue, and then by careful selection of food-grade excipients, formulations of soluble granules described herein include uniformly dispersed lipophilic nutrients in an effective amount of solid hydrophilic carrier. The formulations can provide enhanced solubility and bioavailability of the nutrient. The solubilized granules are further suspended in suitable oil medium, which can result in stabilization of the nutrient. Stable oil suspensions herein include soluble granules of lipophilic nutrients suspended in oil medium. The soluble granules of lipophilic nutrients herein can exhibit enhanced solubility and bioavailability and are further stabilized after being suspended in an oil medium. Such oil suspensions herein can be relatively more permeable than certain marketed comparative formulations, thus reflecting enhanced in vivo absorption phenomenon. Such oil suspensions can be implemented in delivery forms which are convenient for further processing, are not limited by particle size of granules or bulk density. For example, soluble granule compositions can be further formulated or converted into dosage forms like soft gel capsules, dry granules by adsorbing onto solid carrier, or filled in sachets for increasing administration convenience, patient compliance and dose accuracy.

In one embodiment, stable oil suspensions include soluble granules of lipophilic nutrients, suspended in a suitable oil medium.

In one embodiment, a process includes first addressing an inherent poor water solubility property of a lipophilic nutrient and then handling stability problem of these nutrients, to formulate composition, which is convenient to administer and provides dose accuracy.

In one embodiment, solubility of a lipophilic nutrient is increased by uniformly dispersing the nutrient in an effective amount of solid hydrophilic carrier to obtain soluble granules. The soluble granules can be suspended in a suitable oil medium to enhance further bioavailability and confer stability on the lipophilic nutrient.

In one embodiment, in the first step of preparation, soluble granules are prepared using a lipophilic nutrient, an effective amount of at least one hydrophilic carrier, and one or more food grade excipients.

In one embodiment, an amount of solid hydrophilic carrier employed in soluble granules can be present in a ratio of lipophilic nutrients: solid hydrophilic carrier of at or about 1:0.5 to at or about 1:5.

In one embodiment, a process for preparation of soluble granules of lipophilic nutrients includes dispersing the nutrient in an effective amount of solid hydrophilic carrier, and one or more food grade excipients, in a suitable organic solvent which is safe for human consumption, and spray drying to get the solubilized product.

In one embodiment, the soluble granules prepared by dispersing lipophilic nutrient in a solid hydrophilic carrier and spray drying are non-sticky, easy for further processing, and non-cohesive. Although the soluble granules are prepared using sticky lipophilic nutrients, they are convenient for processing into an oil suspension.

In one embodiment, a process for preparation of oil suspension, includes suspending soluble granules in a suitable oil medium, for example with stirring and followed by milling to obtain a uniform, stable, and bioenhanced suspension, containing at or about 1 to at or about 50% by weight of lipophilic nutrient.

In one embodiment, oil suspensions of lipophilic nutrients are described herein, which are stable and exhibit enhanced bioavailability as compared to granules, even after suspending in hydrophobic edible oily medium. The bioavailability of such oil suspensions is many folds increased as compared to certain marketed comparative formulations.

Another objective of the present invention is to provide oil suspensions containing soluble granules of lipophilic nutrients such as fatty acids, fat soluble vitamins, glycerides, carotenoids, curcumin, capsaicin, coenzyme Q 10 as well as Ubiquinol, which are suspended in suitable oil medium.

In one embodiment, soluble granules in the oil suspensions can be further formulated as a soft gelatin capsule or be delivered in the form of sachets, or adsorbed on a solid carrier to form granules, which is convenient to administer to the patients.

Accordingly stable oil suspensions herein can be provided with enhanced bioavailability, containing soluble granules of lipophilic nutrients dispersed in a suitable oil medium; wherein the soluble granules include: at least one lipophilic nutrient; and an effective amount of at least one solid hydrophilic carrier.

In some embodiments, the soluble granules include one or more food grade excipients.

A process for preparation of oil suspensions of soluble granules including lipophilic nutrients is described herein, which are relatively more stable than the soluble granules alone.

The oil suspensions herein can include soluble granules of lipophilic nutrients suspended in a suitable oil medium. The soluble granules include at least one lipophilic nutrient and an effective amount of at least one hydrophilic carrier. In some embodiments, the soluble granules include one or more food grade excipient(s) such as for example but not limited to an antioxidant. Stable oil suspensions can include for example at least 1% to at or about 50% carotenoids.

In some embodiments, free lutein is present for example in combination with zeaxanthin and/or neoxanthin and/or α-cryptoxanthin and/or β-cryptoxanthin and/or mesozeaxanthin. In some embodiments, other excipients and antioxidants may be employed. Such oil suspensions are resistant to oxidation and can exhibit enhanced stability and bioavailability, as compared to granules alone, e.g. soluble granules, as well as compared to certain marketed comparative product(s). Oil suspensions of the invention including the soluble granules can be further formulated into various delivery systems such as soft gel capsules, filled in sachets or adsorbed onto solid carriers to form granules to administer conveniently to the patients.

### DETAILED DESCRIPTION

Described herein are stable and bioenhanced oil suspensions of lipophilic nutrients containing soluble granules suspended in a suitable oil medium, and compositions prepared by encapsulating oil suspensions in compositions such as soft gel capsules and the like. Methods for preparation of soluble granules as well as oil suspensions containing lipophilic nutrients and other compositions thereof are also described.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

The lipophilic nutrients which may be suitable for compositions herein include those which may be sensitive to heat or oxygenating conditions. Though the term “lipophilic” may be referred to as lipid-like, the term generally includes compounds that are poorly water soluble. Non-limiting examples include carotenoids, fat soluble vitamins, fatty acids, glycerides, capsaicin, curcumin and mixtures thereof.

In some embodiments, the lipophilic nutrient is selected from at least one from the group, but not limited to, carotenoids (especially alpha-carotene, beta-carotene, 8′-apo-beta-carotenal, 8′-apo-beta-carotenoic acid esters such as the ethyl ester, canthaxanthin, astaxanthin, astaxanthin ester, betacryptoxanthin, lycopene, lutein, lutein (di) ester, zeaxanthin or crocetin, mesozeaxanthin, alpha or beta-zeacarotene or mixtures thereof), vitamins (A, D, E, K, CoQ 10) or derivatives thereof (such as their acetates, e.g. vitamin A acetate or tocopherol acetate, or their longer chain fatty acid esters, e.g. vitamin A palmitate or tocopherol palmitate), capsaicin, dihydrocapsaicin, derivatives thereof, polyunsaturated fatty acids (PUFAs) or derivatives thereof, and triglycerides rich in polyunsaturated fatty acids such as eicosapentaenoic acid (EPA), docosahexaenoic acid (DHA) or gamma-linolenic acid (GLA), Omega 3, Omega 6 oils or derivatives thereof, ethanolic extracts of Terminalia, Salacia and or mixtures thereof. Further lipophilic nutrients suitable for formulations and compositions herein may include compounds which have a taste or smell which is required to be masked, such as for example but not limited to bitter tasting vitamins and fish oil.

In some embodiments, lipophilic nutrients herein are carotenoids selected from at least one from the group, but not limited to, beta-carotene, lutein, lycopene, astaxanthin, astaxanthin ester, zeaxanthin, neoxanthin, α-cryptoxanthin, β-cryptoxanthin and canthaxanthin. In some embodiments, carotenoids may be used in a combination including free lutein with zeaxanthin and/or neoxanthin and/or α-cryptoxanthin and/or β-cryptoxanthin and the like or the mixtures thereof. Throughout the description the term fat soluble nutrients encompasses the foregoing definition and mixtures of such compounds.

In some embodiments, carotenoids are obtained from Marigold flowers and can be in combinations of free lutein and zeaxanthin, such as for example trans-lutein and zeaxanthin. In some embodiments, the ratio in which the combination of trans-lutein and zeaxanthin are used can vary, for example from at or about 4.5:1 to at or about 5.5:1. In some embodiments, these carotenoids are used in the ratio of 5:1. It will be appreciated that these and other ratios may be used, which may or may not include trans-lutein or zeaxanthin as the carotenoids.

“Soluble granules” herein can be defined as solubilized systems which include a lipophilic nutrient embedded in an effective amount of solid hydrophilic carrier. In some embodiments, the soluble granules can include one or more food grade excipients. In some embodiments, the soluble granules are prepared by a spray drying method.

Soluble granules herein in some embodiments have the active material dissolved in a solvent, have the effective amount of hydrophilic carrier dissolved in another solvent, and then are mixed and spray dried to form granules, wherein lipophilic active is dispersed uniformly in matrix of hydrophilic carrier, e.g. embedded or well surrounded. The soluble granules herein are different from granules formed by melt granulation, which are solid dispersions of the active material in a molten carrier, e.g. where the active material is mixed with a solubilizer and both are melted at elevated temperature and granulated to form a dispersion.

“Hydrophilic carrier” herein can be defined as a food grade excipient, which is soluble in water and imparts its hydrophilic property, when used in an effective amount, so that lipophilic nutrient is embedded well to form soluble granules.

“Effective amount” of solid hydrophilic carrier herein can be defined as the amount used such that lipophilic nutrients get embedded in this excipient and it confers upon its own hydrophilic properties to the hydrophobic nutrient, thus solubilizing it, to form soluble granules. Apart from imparting its hydrophilic properties, this solid carrier also helps to prepare non-sticky and non-cohesive granules of a lipophilic nutrient, which are easy for processing into an oil suspension.

“Embedded’ herein can be defined where the active material, e.g. lipophilic nutrient, is dispersed uniformly in a solid hydrophilic carrier, which provides a matrix to surround the lipophilic nutrient. The result of which can improve processability, for example where the stickiness of the active material, e.g. lipophilic nutrient is addressed, resulting in non-cohesive soluble granules and enhanced solubility, as the effective amount of hydrophilic carrier imparts its hydrophilicity to the active material. In some embodiments, at least one food ingredient present in the matrix of the solid hydrophilic carrier can provide stability to the active material.

The soluble granules herein can be non-sticky and non-cohesive systems, wherein lipophilic nutrients are conferred hydrophilic properties to enhance solubility and release of active by using an effective amount of a solid hydrophilic carrier, and may be used in a first step in the formulation of oil suspensions. Although the granules are prepared from sticky starting material such as lipophilic nutrient, the soluble granules are non-cohesive and can aid in further processing.

An “oil”, herein can be defined as any neutral, nonpolar chemical substance that is a viscous liquid at ambient temperatures and is both hydrophobic (immiscible with water) and lipophilic (miscible with other oils), the oils used herein are food grade or edible oils and may be selected from a animal, vegetable, or synthetic source.

According to one embodiment, granules of lipophilic nutrients are prepared as a first step of formulation by using an effective amount of solid hydrophilic carrier. Resulting soluble granules exhibit desired solubility and active release properties, owing to embedding of lipophilic nutrient in solid hydrophilic carrier, thus conferring its properties to resulting granules and increasing the solubility. As a second formulation step, when these granules are further suspended in suitable liquid medium such as oil, it was observed that such oil suspension exhibits enhanced stability and solubility as compared to granules as well as to certain marketed products. Oil suspensions herein include soluble granules of lipophilic nutrients, suspended in an oil medium and, stabilized from inherent oxidation by employing one or more food grade excipient such as for example but not limited to antioxidant during preparation of the soluble granules.

As the soluble granules are suspended in oil, these oil suspensions do not have any limitation of solid dosage forms like bulk density and particle size and thus are convenient to be further formulated or converted into soft gel capsules, or filled in sachets or transformed into granules by adsorbing on suitable solid excipient (for example where the oil suspension with the soluble granules may be adsorbed onto a carrier excipient to form for example a free flowing granular powder), which can provide for ease of administration to consumers. It was also observed that resulting compositions exhibit improved stability and desired dissolution profile.

In another embodiment, a stable system is provided which acts as an immediate release formulation in the form of oil suspensions of lipophilic nutrients and its subsequent compositions, which are convenient to administer to consumers of different age groups and results in patient compliance and therapeutic efficacy.

In one embodiment, soluble granules are prepared by dispersing lipophilic nutrient and an effective amount of solid hydrophilic carrier in an organic solvent, which is acceptable for human consumption, and by spray drying the dispersion to obtain soluble granules of lipophilic nutrients. The soluble granules herein in some embodiments include carotenoids, which in some examples include a combination of free lutein and zeaxanthin, embedded in an effective amount of solid hydrophilic carrier. One or more food grade excipients are included in the dispersion.

In some embodiments, the solid hydrophilic carrier employed in preparation of the soluble granules is selected from at least one of the group, but not limited to, cellulose derivatives, polyacrylates, polyethylene glycols, povidones, starch, starch derivatives, gums, sugars, and the like.

In some embodiments, the solid hydrophilic carrier may be selected from at least one of the group, but not limited to, cellulose and cellulose derivatives, but not limited to, alkyl cellulose (methyl cellulose), a hydroxyalkyl cellulose (e.g., hydroxymethyl cellulose, hydroxypropyl cellulose), carboxyalkyl cellulose (e.g., carboxymethyl cellulose and alkali metal salts thereof, such as sodium salts), a carboxyalkylalkyl cellulose (e.g., carboxymethylethyl cellulose), a carboxyalkyl cellulose ester (e.g., carboxymethyl cellulose butyrate, carboxymethyl cellulose propionate, carboxymethyl cellulose acetate butyrate, and carboxymethyl cellulose acetate propionate), and the like.

In some embodiments, the solid hydrophilic carrier may be selected from the group of polyacrylates, for example selected from at least one of the group, but not limited to polymethacrylate, a methacrylate copolymer (e.g., a methacrylic acid-methyl methacrylate copolymer, dimethylaminoethyl methacrylate-butyl methacrylate-methyl methacrylate copolymer, and a diethylaminoethyl methacrylic acid-methyl methacrylate copolymer), and an ethacrylate copolymer (e.g. methacrylic acid ethacrylate copolymer), and the like.

In some embodiments, the hydrophilic carrier may be selected from the group of povidones, for example selected from at least one of the group, but not limited to polyvinyl pyrrolidone (e.g., Povidone), polyvinyl acetate ester (e.g., polyvinyl acetate phthalate (PVAP)), and a polyethylene glycol polyvinylacetate copolymer (e.g. polyethylene glycol-polyvinylcaprolactam-polyvinylacetate copolymer), and the like.

In some embodiments, the solid hydrophilic carrier may also be selected from the group of polyethylene glycols, for example selected from at least one of the group, but not limited to polyalkylene oxide (e.g., polyethylene glycols, such as PEG 300, PEG 400, PEG 4000, and PEG 8000, and polypropylene glycols), a copolymer of ethylene oxide and propylene oxide (e.g., ethoxylated propoxylated block copolymers, and a polyethoxylated glyceryl ester (e.g., polyoxyl 35 castor oil and polyoxyl 40 castor oil having 40-45 moles of ethylene oxide), and the like.

In some embodiments, the hydrophilic carrier may be selected from at least one of the group , but not limited to starch and starch derivatives, but not limited to, dextrins, acid-treated starch alkaline-treated starch, bleached starch, oxidized starch derivatives, enzyme-treated monostarch phosphate, distarch phosphate, phosphated distarch phosphate, acetylated distarch phosphate, starch acetate, acetylated distarch adipate, hydroxypropyl starch, hydroxypropyl distarch phosphate, hydroxypropyl distarch glycerol, starch sodium octenyl succinate, acetylated oxidized starch and the like.

In some embodiments, the hydrophilic carrier may be selected from the group such as gums for example selected from at least one of the group, but not limited to pectin, alginate, carrageenan, agar, Gum arabic, Gum tragacanth, Gum karaya, Gum ghatti, Gum guar, Locust bean gum, Tara gum, Xanthan gum, Gellan gum, Welan gum and the like.

In some embodiments, the hydrophilic carrier may be selected from the group such as sugars and alcohols for example selected from at least one of the group, but not limited to glycerol, sorbitol, glucose syrup, corn steep liquor, mannitol, sucrose, glucose, sodium chloride, polyvinyl alcohol, and mixtures thereof and the like.

In some embodiments, the hydrophilic carrier excipient may be polyvinyl pyrrolidone (PVP). It will be appreciated that various grades of polyvinyl pyrrolidone can be employed within the scope of the soluble granules, formulations, and compositions thereof.

In some embodiments, the hydrophilic carrier is used in an effective amount to obtain the soluble granules. The amount of hydrophilic carrier incorporated into soluble granules is such that it is effective to impart its hydrophilic properties to the matrix of lipophilic nutrient, thus increasing their solubility. In some embodiments, the hydrophilic carrier is included in the granules so that a ratio of carotenoid to such carrier is at or about 1:0.5 to at or about 1: 5.

In some embodiments, the amount of carotenoid, used in the soluble granules can vary for example from at or about 1% to at or about 50%. In some embodiments, the amount can be from at or about 2 to at or about 25%. These granules contain carotenoids, which in some embodiments is present in the form of a combination of free lutein and zeaxanthin.

In some embodiments, a size of the granules can be for example but not limited to at or about 0.5 to at or about 30 microns, as analyzed by a Malvern instrument, after suspending into oil suspension, by following a process of stirring and milling of a suspension to obtain a homogeneous dispersion of granules in an oil medium.

Stable oil suspensions herein can be formed of soluble granules of carotenoids, suspended in a suitable oil, wherein soluble granules are comprised of a lipophilic nutrient, an effective amount of solid hydrophilic carrier and in some embodiments, one or more food grade excipient(s).

The one or more food grade excipients can include, but are not limited to, diluents, antioxidant, surfactant, binders, solvents, and the like. For example, pharmaceutical excipients are can be incorporated into solid dosage forms, so as to ease the manufacturing process as well as to improve the performance of the dosage form.

In some embodiments, the one or more food grade excipients can include one or more of antioxidants, surfactants and/or stabilizers, such as for example tocopherol, Tweens/Spans, and/or sodium ascorbate. The food grade excipients can stabilize the active ingredient and/or enhance bioavailability.

It will be appreciated that the list of food grade excipients is different from the above examples for the hydrophilic carrier. The hydrophilic carrier and the food grade excipient perform specific functions, (e.g. hydrophilic carrier embeds the lipophilic nutrient in a matrix of the hydrophilic carrier, the food grade excipient(s) imparts stability, sometimes solubility (surfactant/solubilizer) and processability for spray drying).

As per one of the embodiment, an effective amount employed for the hydrophilic carrier is significantly higher, e.g. the lipophilic nutrient: hydrophilic carrier ratio is at or about 1:0.5 to 1:5 , (see e.g. Formula I to V in which hydrophilic carrier is used in amounts more than 1:1 of such ratio). Hydrophilic carrier is used in relatively higher amounts so that it can embed the lipophilic active or provide a matrix to make it soluble. Further, the amount of food grade excipient used may range from at or about 0.1% to at or about 4% by weight of the total composition.

In some embodiments, examples of suitable diluents can include, but are not limited to, starch, dicalcium phosphate, microcrystalline cellulose, lactose monohydrate, dextrate hydrated, colloidal grade carboxymethyl cellulose sodium, carboxymethyl cellulose calcium and other cellulose containing polymers and their derivatives or the like and mixtures thereof. In some embodiments, a suitable diluent is selected from at least one of conventional marketed grades of microcrystalline cellulose, including, but not limited to Avicel®PH 101, Avicel®PH 102, Avicel®PH 103, Avicel®PH 105, Avicel®PH 112, Avicel®PH 113, Avicel® PH 300, Avicel®PH 212, Avicel®PH 301, Avicel®PH 302, and the like or mixtures thereof.

In some embodiments, the antioxidant is selected from excipients including, but not limited to α-Tocopherol, β-Tocopherol, γ-Tocopherol, mix Tocopherol, citric acid, Rosemary extract, ascorbyl palmitate, sodium ascorbate or the like and the combinations thereof.

Suitable surfactants can include, but are not limited to, anionic and non-ionic surfactants or a mixture thereof. The non-ionic surfactants employed in the composition may include, but are not limited to, ethoxylated fatty acid ester, ethoxylated fatty acid ethers, ethoxylated sorbitan ethers, ethoxylated alkyl-phenols, glycerol esters, glycerol sugar esters, polyoxyethylene glycerol monolaurate, polyoxyethylene glycerol monostearate, polyoxyethylene-20-cetyl stearate, polyoxyethylene-25-cetyl stearate, polyoxyethylene(25)-oxypropylene monostearate, polyoxyethylene-20-sorbitan monopalmitate, poly-oxyethylene-16-tert-octylphenol, polyoxyethylene-20-cetyl ether, polyethylene glycol(1000)monocetyl ether, ethoxylated castor oil, polyoxyethylene sorbitol-lanolin derivatives, polyoxyethylene(25)propylene glycol stearate, polyoxyethylenesorbitol esters, polyoxyethylene-20-sorbitan monopalmitate, polyoxyethylene-16-tert-octylphenol, polyoxyethylene-20-cetyl ether, glycyeryl undecylenate and Polysorbate 60, capmul (medium chain glyceride), peceol(glyceryl monooleate), glyceryl laurate and glyceryl caprylate (Capmul MCM), PEG sorbitan fatty acid esters like PEG-20 sorbitan monolaurate (Tween 20), PEG-20 sorbitan monostearate (Tween 60), PEG-20 sorbitan monooleate (Tween 80), sorbitan fatty acid esters like sorbitan monolaurate (Span 20), glyceryl stearate (Cithrol GMS) or the like and mixtures thereof. Suitable anionic surfactants include, but are not limited to, fatty alcohol sulfates, alpha olefin sulfonates, sulfosuccinates, phosphate esters, carboxylates, sarcosinates, alkyl benzene sulfonates, alkyl sulfonates, olefin sulfonates, alkyl ethersulfonates, glycerol ethersulfonates, alpha-methyl estersulfonates, sulfonic fatty acids, alkyl sulfates, fatty alcohol ethersulfates, glycerol ethersulfates, mixed hydroxy ethersulfates, monoglyceride(ether)sulfates, fatty acid amide(ether)sulfates, sulfosuccinates, sulfosuccinamates, sulfotriglycerides, alkyl oligoglycoside sulfates, alkyl(ether)phosphates or the like and mixtures thereof.

In some embodiments, processes for preparation of soluble granules of lipophilic nutrient are described; wherein the nutrient is dispersed in suitable polar or non polar solvent or a mixture of polar and non-polar solvents. The solid hydrophilic carrier is also dissolved in a suitable polar solvent to form a clear solution and is mixed with at least one more food grade excipient. The dispersion of the lipophilic nutrient is then mixed well with the solution of hydrophilic carrier and excipient and subjected to spray drying to remove solvent to obtain soluble granules of lipophilic nutrient.

In some embodiments, the one or more solvents employed in a process for preparation of soluble granules may be at least one selected from the group such as, but not limited to, acetone, hexane, ethyl acetate, isopropyl alcohol, ethanol, dichloromethane, methanol, and a mixture thereof, more preferably from acetone, ethanol, dichloromethane, isopropyl alcohol, and more preferably dichloromethane and isopropyl alcohol.

In some embodiments the non-polar solvents which may be used for preparing the dispersion of lipophilic nutrient include, but not limited to, methylene chloride, chloroform, petroleum ether (low boiling), petroleum ether (high boiling) and the like or the mixtures thereof.

In some embodiments, the polar solvents, which may be used for preparing the solution of solid hydrophilic carrier, include, but is not limited to, isopropyl alcohol, acetone, methanol, ethanol, acetonitrile or mixtures thereof.

The non-polar solvent and polar solvent can be used in varying ratios, such as for example ratios of at or about 1:1 to at or about 0.1:1, and in some embodiments, the ratio can be at or about 0.2:1 to at or about 2:1. For instance, the non-polar and polar solvents can include a mixture of methylene chloride and isopropyl alcohol at a ratio of about 1:1 to about 0.1:1. The non-polar and polar solvents can also include a mixture of methylene chloride and isopropyl alcohol at a ratio of about 0.2:1 to about 2:1.

Soluble granules herein are suspended in suitable liquid medium such as oil in a ratio of at or about 1:1 to at or about 1:3 to result into suspension in which granules are dispersed well. Oils employed for this purpose are edible or food grade category and may be selected from animal, vegetable or synthetic source and are rich sources of medium chain triglycerides.

Oils herein can be at least one selected from the group, such as, but not limited to sunflower oil, safflower oil, coconut oil, corn oil, cotton seed oil, canola oil, olive oil, palm oil, peanut oil, sesame oil, soybean oil, grape seed oil, pumpkin seed oil, argan oil, rice bran oil and other vegetable oils, as well as animal-based oils like butter and lard and the like. In some embodiments, the oil employed to suspend the granules is selected from soybean, safflower, and/or sunflower oil.

In some embodiments, soluble granules of lipophilic nutrient are suspended in a suitable oil by using a homogenizer followed by milling to obtain an oil suspension containing granules of lipophilic nutrient.

In some embodiments, oil suspensions of the soluble granules including the lipophilic nutrient can be further formulated or incorporated into a suitable dosage form, such as soft gel capsules by encapsulation or packed in sachets for convenience of administration or can be adsorbed on solid hydrophilic carrier to form granules, which can be employed in beverages or filled in hard gelatin capsules.

In some embodiments, oil suspensions are evaluated for stability, release of active material, and absorption and compared to granules alone, e.g. soluble granules, as well as compared to composition such as soft gel capsules. Release of active material is studied by a dissolution study in a relevant dissolution medium. Absorption of active material from the oil suspension is evaluated by intestinal permeability studies using an everted rat intestinal sac method and compared with certain marketed comparative formulations.

With reference to marketed “comparative” formulations, products including oil suspension products, gel capsules including soft gel capsules described herein including the Examples and Tables below, comparisons are made to a composition that contains lutein suspended in edible triglyceride oil (e.g. safflower oil), where the composition contains 20% or more of lutein and 0.8% zeaxanthin. The lutein composition in a crystallized form itself has more than 80% total carotenoids, of which lutein is included at or more than 85% and zeaxanthin is at or less than 9%. It will be appreciated that similar results may be expected from other compositions of lipophilic nutrients, e.g. xanthophylls, such as for example lutein crystals, which are suspended in oil, but where the xanthophylls are not made into soluble granules.

It will be appreciated that certain modifications and equivalents will be apparent to those skilled in the art and are intended to be included within the scope of the invention and the embodiments disclosed herein. The examples, details, and advantages explained hereunder are intended to be non-limiting exemplary illustrations.

### EXAMPLES

### Example 1

### Preparation of Carotenoid Crystals

The preparation of a carotenoid concentrate is described in Indian Patent Application No. 622/MAS/2002 (U. S. Pat. No. 6,737,535), the disclosures of which are incorporated by reference herein in its entirety, and is summarized as follows.

Commercial grade marigold extract (57.98 g) containing 11.54% free lutein-zeaxanthin content (by spectrophotometric method) was mixed with potassium isopropyl alcoholate (prepared by dissolving 15 g potassium hydroxide in 175 ml isopropanol.) The saponification mixture was heated and maintained at 70° C. for a period of 3 hours. The degree of hydrolysis was monitored by high performance liquid chromatography (HPLC) during the saponification stage. Isopropanol was distilled off under reduced pressure and the solids obtained were stirred with 230 ml of water at room temperature. The mixture was taken into a reparatory funnel and extracted with equal volume of ethyl acetate (3 times). Ethyl acetate layer was collected and washed with distilled water for removing the excess alkali, soapy materials and other water-soluble impurities. The ethyl acetate layer was distilled off under reduced pressure to get saponified crude extract (25.01 g). This resultant crude extract (25.01 g) was subjected to purification by stirring with 100 ml of hexane/acetone mixture (80:20) at room temperature for 30 minutes, followed by filtration. The precipitate of carotenoid crystals obtained was washed with methanol. The resulting orange crystals were vacuum dried at ambient temperature for 72 hrs. The yield of the crystals was 3.41% (1.98 g). Carotenoid content was 86.23% by weight (as determined by ultra violet-visible (UV/Vis) spectrophotometry) out of which the contents of trans-lutein, zeaxanthin, and other carotenoids were 91.43%, 6.40% and 2.17% respectively as determined by HPLC analysis.

### Example 2

### Preparation of oil suspension from granules of Carotenoids

TABLE 1
Composition of carotenoid oil suspension

| | Formula | Formula | Formula | Formula | Formula |
|---|---|---|---|---|---|
| Ingredients | I | II | III | IV | V |
| Carotenoids (Free | 12.50 | 12.50 | 12.50 | 12.50 | 12.50 |
| lutein and zeaxanthin | | | | | |
| concentrate ) | | | | | |
| Mixed Tocopherol | 0.92 | 0.92 | 0.92 | 0.92 | 0.92 |
| Tween 80 | 2.63 | 2.63 | 2.63 | 2.63 | 2.63 |
| Sodium Ascorbate | 1.71 | 1.71 | 1.71 | 1.71 | 1.71 |
| Povidone K 30 | 15.58 | 15.58 | 15.58 | — | — |
| Modified starch | — | — | — | 15.80 | — |
| Maltodextrin | — | — | — | — | 15.80 |
| Isopropyl Alcohol | 6.00 | 6.00 | 6.00 | 6.00 | 6.00 |
| Methylene Dichloride | 294.00 | 294.00 | 294.00 | 294.00 | 294.00 |
| Soybean Oil | 66.66 | — | — | 66.66 | 66.66 |
| Sunflower Oil | — | 66.66 | — | — | — |
| Safflower Oil | — | — | 66.66 | — | — |
| Total | 100 | 100 | 100 | 100 | 100 |

Process for preparation of Formula I to Formula V

Step 1: Preparation of soluble granules of carotenoids

Isopropyl alcohol was mixed with methylene dichloride in to suitable vessel and carotenoid concentrate was added to this solvent system under stirring. Required amount of polyvinyl pyrrolidone (Povidone K 30 (PVP K30)) was added in above dispersion with stirring. Mixed tocopherol and tween 80 were added sequentially to above mixture. Weighed amount of sodium ascorbate was sifted through 100 mesh and added to the system with continuous stirring. Resulting dispersion was milled through colloid mill for 15 to 30 minutes and passed through 80 mesh. This was subjected to spray drying by adjusting suitable parameters to get granules of carotenoids.

Step 2: Preparation of oil suspension of carotenoid granules

Weighed amount of suitable oil (Soybean oil/Safflower oil/Sunflower oil) were transferred to mixing vessel and granules of carotenoids were added to this liquid medium under stirring until the granules were dispersed. The resulting oil suspension of carotenoids was further stirred for 60 minutes and passed though colloid mill twice followed by filtration of resulting oil suspension.

### Example 3

### Stability Study of Carotenoid granules and Oil suspension

Carotenoid granules and oil suspension of Formula I (Product) were subjected to accelerated stability study at 40° C.±2° C./75% relative humidity (RH)±5% RH for the period of 6 months. Product was packed in sealed aluminum bottle and incubated in stability chambers. The granules and oil suspension were analyzed for lutein (L) and zeaxanthin (Z) content at definite time intervals. The result is tabulated in Tables 2 and 3 respectively.

TABLE 2
Lutein and Zeaxanthin content in carotenoid granules

| | Initial (%) | | 1 Month | | 2 Month | | 3 Month | | 6 Month | |
|---|---|---|---|---|---|---|---|---|---|---|
| Example | L | Z | L | Z | L | Z | L | Z | L | Z |
| Formula I | 22.62 | 5.00 | 20.60 | 4.80 | 20.14 | 4.58 | 20.5 | 4.56 | 19.56 | 4.54 |

L—Lutein,
Z—Zeaxanthin

TABLE 3
Lutein and Zeaxanthin content in oil suspension during stability study

| | Initial (%) | | 1 Month | | 2 Month | | 3 Month | | 6 Month | |
|---|---|---|---|---|---|---|---|---|---|---|
| Example | L | Z | L | Z | L | Z | L | Z | L | Z |
| Formula I | 8.17 | 1.54 | 7.69 | 1.54 | 7.62 | 1.43 | 7.5 | 1.47 | 7.48 | 1.53 |

L—Lutein,
Z—Zeaxanthin

It was found that as shown in Table 2, carotenoid soluble granules exhibit certain drop (about 12 to 15%) in stability with respect to Lutein content over a period of 6 months. But when these granules are suspended in suitable oil medium, the resulting oil suspension is stabilized and the percentage drop in lutein content is significantly lowered to around 5%, as evident from Table 3. Thus oil suspensions of granules exhibit enhanced stability and can be stored over a period of shelf life, without affecting active content.

### Example 4

### Preparation of carotenoid soft gel capsules from oil suspension

Carotenoid oil suspension was encapsulated in a soft gel using a suitable oval die, employing a spread box temperature of 55° C. and a segment temperature 39 ° C. and a ribbon thickness was adjusted as 0.85 mm. Soft gel capsules were dried at 23 ° C. with RH 18% for 48 hrs. The capsules were examined physically for integrity and leakage. It was found that there was no leakage, fracture or discoloration during sealing and storage. Thus the capsules were stable during shelf life at storage conditions.

### Example 5

### Dissolution data of carotenoid granules, oil suspension and soft gel capsules

Carotenoid granules, oil suspension and soft gel capsules were subjected to dissolution study employing a USP type II (Paddle) apparatus and using 1000 ml of pH 6.8 buffer with 2.0% sodium lauryl sulfate (SLS) as dissolution medium at 100 rpm. Along with this, marketed soft gel capsules were also subjected to dissolution and mean % release (average) data of lutein release is shown in Table 4.

TABLE 4
Average Lutein release from granules, oil
suspension and soft gel capsules of carotenoids

| Time | Granules | Oil Suspension | Soft gel capsules | Marketed Soft gel |
|---|---|---|---|---|
| (min) | Formula I | Formula I | Formula I | capsule |
| 15 | 81.42 | 52.80 | 42.84 | 14.53 |
| 30 | 85.36 | 67.78 | 75.44 | 62.74 |
| 45 | 88.48 | 84.60 | 92.90 | 90.36 |
| 60 | 91.59 | 94.02 | 99.89 | 99.88 |
| 90 | 97.81 | 108.28 | 109.50 | 99.54 |

The dissolution study indicates that soluble granules exhibit fast release of lutein at initial time point, but lutein release from granules, oil suspension and soft gel capsules of the invention was comparable after 45 minutes. In spite of suspending the granules in oil medium and encapsulating into soft gel, lutein was released efficiently after 30 minutes. Release of lutein from certain marketed soft gel capsules was slower at initial time point as compared to oil suspension and soft gel capsules of the invention. Thus granules suspended in suitable oil and encapsulated in soft gel capsules exhibit desirable release rate of lipophilic nutrient as compared to release from granules.

### Example 6

### Evaluation of Intestinal Permeability of Lutein by Everted Rat Intestinal Sac Method

Rat everted intestinal sac was prepared by opening rat abdomen under anesthesia and selecting middle small intestine by flushing with Kreb's buffer solution and everting the prepared sac by pushing a rod through whole length of intestine. Total surface area of the everted sac of the small intestine was recorded and the sac was filled with Kreb's solution and placed in a beaker containing specific concentration of test item. The sacs were incubated up to 60 minutes and sample was withdrawn from the serosal side of the sac and processed for HPLC analysis. Concentrations were measured and values were used to calculate the apparent permeability. The experiment was carried out in duplicate for every sample, and a mean apparent permeability was calculated from a permeability study, where results were recorded in following Table 5. The direction of permeability was from the intestinal mucosa to the serosal side. The samples evaluated for permeability by this method were as follows:

Sample I: Soluble Granules of lipophilic nutrient

Sample II: Oil suspension of granules in safflower oil base (Formula III)

Sample III: Oil suspension of granules in Soybean oil base (Formula I)

Sample IV: Marketed comparative lutein oil suspension product

TABLE 5
Apparent Permeability of Lutein from test samples

| | Mean, Apparent Permeability |
|---|---|
| Sample | (10⁻⁰⁶ cm/sec) |
| Sample I | 0.02 |
| Sample II | 0.195 |
| Sample III | 0.443 |
| Sample IV | 0.009 |

Evaluation of intestinal permeability study by everted sac method indicates that apparent permeability exhibited by oil suspension comprising granules of lipophilic nutrients in Soybean oil medium is significantly more than granules as well as oil suspension comprising granules of lipophilic nutrients in Safflower oil medium. Apparent permeability for marketed product suspension was considerably lower than oil suspension of the both Samples II and III. As the permeability is directly related to absorption through body cells, high apparent permeability indicates that oil suspension in soybean oil medium exhibits enhanced bioavailability as compared to soluble granules and thus are useful and convenient to administer to patients of all age groups.

1. Stable oil suspension with enhanced bioavailability comprising,
at least one lipophilic nutrient,
effective amount of at least one solid hydrophilic carrier and one or more food grade excipients;
wherein the said lipophilic nutrient is uniformly dispersed in solid hydrophilic carrier to form soluble granules and then suspended in an oil, which suspension can be formulated into compositions such as soft gel capsules, sachets and the like.

2. Stable oil suspension of claim 1, wherein the lipophilic nutrient is at least one selected from carotenoids, vitamins, omega fatty acids, glycerides, capsaicin, curcumin, extracts of Salacia, Terminalia, Co-Enzyme Q-10, Ubiquinol and mixtures thereof.

3. Stable oil suspension of claim 2, wherein the lipophilic carotenoid nutrient is at least one selected from the group consisting of lutein, lutein esters, alpha carotene, beta-carotene, zeaxanthin, mesozeaxanthin, betacryptoxanthin, zeaxanthin esters, astaxanthin, lycopene and mixtures thereof.

4. Stable oil suspension of claim 1, wherein the solid hydrophilic carrier is at least one selected from cellulose derivatives, polyacrylates, polyethylene glycols, povidones, starch and starch derivatives, gums, sugars, and the mixtures thereof.

5. Stable oil suspension of claim 4, wherein the solid hydrophilic carrier is at least one selected from the group of povidones such as polyvinyl pyrrolidone, polyvinyl acetate ester, and a polyethylene glycol polyvinylacetate copolymer and the mixtures thereof.

6. Stable oil suspension of claim 5, wherein the ratio of lipophilic nutrient to hydrophilic carrier is 1:0.5 to 1:5.

7. Stable oil suspensions of claim 1, wherein the suitable oil is at least one selected from sunflower oil, safflower oil, coconut oil, corn oil, cotton seed oil, canola oil, olive oil, palm oil, peanut oil, sesame oil, soybean oil and the mixtures thereof.

8. Stable oil suspensions of claim 1, wherein the one or more food grade excipients is at least one selected from diluents, antioxidant, surfactant, binders, solvents, and the mixtures thereof.

9. A process for preparation of stable oil suspensions with enhanced bioavailability, comprising,
i) dispersing the lipophilic nutrient in a suitable polar or non polar solvent or mixture of polar and non-polar solvents;
ii) dissolving the solid hydrophilic carrier in a suitable polar solvent to form clear solution and mixing with one or more food grade excipients;
iii) mixing dispersion of the lipophilic nutrient with solution of solid hydrophilic carrier;
iv) subjecting to spray drying to remove solvent to obtain soluble granules of lipophilic nutrient; and
v) suspending the granules of lipophilic nutrients in suitable oil with stirring followed by milling.

10. Stable oil suspension prepared by process of claim 9, which is comprised of 1 to 50% by weight of lipophilic nutrient.
